(19) United States
(12) Patent Application Publication
(10) Pub. No.: US 2012/0088860 A1
(43) Pub. Date: Apr. 12, 2012

(54) ANTIMICROBIALLY EQUIPPED MATERIALS

(75) Inventors: Rüdiger Wissemborski, Gau-Algesheim (DE); David Kümmet, Budenheim (DE); Hendrik Wermter, Eltville (DE); Rainer Schnee, Mainz (DE); Thomas Futterer, Ingelheim (DE)

(73) Assignee: CHEMISCHE FABRIK BUDENHEIM KG, Budenheim (DE)

(21) Appl. No.: 13/322,791

(22) PCT Filed: May 21, 2010
(86) PCT No.: PCT/EP10/57064

§ 371 Date: Dec. 29, 2011

(30) Foreign Application Priority Data
May 28, 2009 (DE) 10 2009 026 539.2

(51) Int. Cl. C08K 3/32; C08L 23/06

(52) U.S. Cl. 523/100; 523/122

(57) ABSTRACT

An antimicrobially treated material comprising a matrix material in which inorganic phosphate salts of at least two different metal cations are contained in finely distributed, dispersed or dissolved form, wherein at least one of the metal cations is selected from copper (Cu) and zinc (Zn).

### SUBJECT—MATTER OF THE INVENTION

The invention concerns an antimicrobially treated material comprising a matrix material in which inorganic phosphate salts are finely distributed, dispersed or dissolved, imparting antimicrobial properties to the material. The invention further concerns the use of inorganic phosphate salts for the production of materials which are antimicrobially treated according to the invention, and the use of the material according to the invention for the production of packaging materials for commercial products, preferably packaging materials for foodstuffs, cosmetic agents, medicines or medical products, or for the production of medical products or plastic tubes.

### BACKGROUND OF THE INVENTION

For hygiene reasons there is a need for articles of everyday life, packaging materials for commercial products, textiles, medical equipment and disposable articles, conduits for water and other foodstuffs etc. to be antimicrobially treated.

There are already now possible ways of antimicrobially treating fibres, for example by the application of surfactants or biocides and germicides which however are frequently not entirely safe and often do not have a long-lasting action. The known antimicrobial action of silver is already used in the form of colloidal elementary silver with particle sizes in the nanometer range for the treatment of fibres such as for example cotton threads. By way of example mention will be made in this respect of U.S. Pat. No. 5,985,308, U.S. Pat. No. 5,374,432, U.S. Pat. No. 6,949,598, U.S. Pat. No. 7,270,694 and U.S. Pat. No. 7,052,765. The silver is oxidised at its surface and the resulting silver ions have an inhibiting effect on the growth of the germs on the fibre. In that case the silver is used in levels of concentration at which bacteria are killed off. It will be noted however that the silver is also not always completely safe for the human organism. The reason for this is the persistence of silver, that is to say an increase in content thereof in the human body, which in extreme cases can lead to argyria or even argyrosis.

It is further known that copper and copper salts have a bacteriostatic action. The American environmental authority EPA (Environmental Protection Agency) has confirmed the antimicrobial effectiveness of copper surfaces. The tests prescribed by the EPA showed that 99.9% of the bacteria on copper alloy surfaces were eliminated within an exposure time of two hours. By way of example in that respect attention is directed to EP-A-2 012 590. It will be noted however that the use of copper metal is already only restricted or not possible at all because of its red basic colour and its conductivity in many systems.

EP-A-1 978 138 describes the use of copper oxide and establishes that the antimicrobial action is based on the copper ions. A disadvantage here is inter alia the dark colour of the copper oxide and the poor compatibility in systems with alkali incompatibility.

U.S.-A-2007010579 relates to an organic copper salt whose disadvantages however are decomposition and lack of temperature resistance.

The problem of the present invention was that of antimicrobially treating a material and in so doing achieving an antimicrobial action which is improved over the state of the art and at the same time overcoming the disadvantages of known antimicrobial treatments in respect of harmfulness to health, decomposition and/or temperature sensitivity of the antimicrobial agent.

In accordance with the invention that problem is solved by an antimicrobially treated material comprising a matrix material in which inorganic phosphate salts of at least two different metal cations are finely distributed, dispersed or dissolved, wherein at least one of the metal cations is selected from copper (Cu) and zinc (Zn).

The expression antimicrobial properties in accordance with the present invention signifies bacteriostatic, fungicidal or antiviral properties or a combination of several of those properties.

It was surprisingly found that the antimicrobial properties of a material can be markedly improved by a combination of at least two different metal phosphates with different metal cations of which at least one is copper (Cu) or zinc (Zn), in comparison with known antimicrobial agents. A synergistic effect of metal phosphate combinations according to the invention was surprisingly also found.

The reference to a synergistic effect is used to mean that the combination of the synergists exhibits an action which is significantly higher than the action of the respective individually used synergists with the same total amount or overall concentration for the synergists in each case. In other words, to achieve an equally good action, a significantly smaller overall amount or overall concentration of the combination of the synergists is required, than the respective individually used synergists.

What is important according to the invention is the combination of at least two various metal phosphates with different metal cations. The metal phosphates can however have identical or different phosphate anions.

Preferably in accordance with the invention the inorganic phosphate salts are selected from orthophosphates, diphosphates, metaphosphates, more highly condensed phosphates and mixed hydroxide-phosphate-oxoanions.

In a preferred embodiment of the invention the at least two different metal cations are copper (Cu) and zinc (Zn). The matrix material thus contains a combination of copper phosphate and zinc phosphate. That combination has proven to be antimicrobially particularly effective.

In a further preferred embodiment of the invention at least one of the metal phosphate salts is an acid phosphate. The use of acid zinc phosphate, preferably monozinc phosphate Zn(H₂PO₄)₂, in combination with at least one further metal phosphate, preferably a copper phosphate, has proven to be particularly antimicrobially effective.

In a further preferred embodiment of the invention the at least one metal phosphate is a copper phosphate, preferably copper hydroxide phosphate Cu₂(OH)PO₄. Still a further preferred embodiment of the invention involves using copper hydroxide phosphate Cu₂(OH)PO₄ in combination with acid zinc phosphate, preferably monozinc phosphate Zn(H₂PO₄)₂.

In a further preferred embodiment of the invention at least one or both of the metal phosphate salts is or are selected from:

Copper hydroxide phosphate Cu₂(OH)PO₄,

Tricopper phosphate Cu₃(PO₄)₂,

Copper-II-pyrophosphate Cu₂P₂O₇,

Monozinc phosphate Zn(H₂PO₄)₂,

Trizinc phosphate Zn₃(PO₄)₂,

Zinc pyrophosphate Zn₂P₂O₇.

Copper ions and zinc ions do not have persistent properties in comparison with silver. Upon overdosing copper and zinc are secreted from the body again. Both metals are essential trace elements which are required in body-specific processes.

An advantage of the use of copper phosphates over metallic copper is that they do not involve the generally undesirable red basic colour and the conductivity of the copper metal. Zinc phosphate is almost colourless and can therefore be incorporated even into light matrix materials without entailing an unwanted colouration effect.

The weaker antibacterial action of copper and copper salts in relation to silver and silver salts can surprisingly be compensated and possibly even bettered by the combination of copper phosphate with other metal phosphates, in particular zinc phosphates, but also aluminium or potassium phosphates.

The amount or concentration in which each of the metal phosphate salts is contained in finely distributed, dispersed or dissolved form in the matrix material depends on the effectiveness of the metal phosphate combination which the man skilled in the art can easily ascertain by simple tests, the actually desired or required antimicrobial properties of the material and further circumstances, and can be set by the man skilled in the art. In a preferred embodiment of the invention the at least two inorganic metal phosphate salts are contained in the matrix material however in a respective amount of 0.001 to 40% by weight or 0.05 to 10% by weight or 0.5 to 5% by weight or 1 to 3% by weight. Excessively large amounts of metal phosphates increase the costs involved in production of the material and can have an unwanted detrimental influence on the material properties of the matrix. Excessively small amounts of metal phosphates could result in a low level of antimicrobial effectiveness.

In a further preferred embodiment of the invention the at least two inorganic metal phosphate salts are respectively of a mean particle size (d50) in the range of 1 nm to 20 μm, preferably 10 nm to 10 μm, particularly preferably 20 nm to 1 μm, quite particularly preferably 40 nm to 200 nm.

Any matrix material in which the metal phosphates according to the invention can be incorporated is suitable for implementation of the present invention. The matrix material is particularly appropriately and preferably selected from organic polymer materials, particularly preferably from thermoplastic polymers, thermosetting polymers, resins and silicones. Polymer materials which are suitable according to the invention are polyvinylbutyral (PVB), polypropylene (PP), polyethylene (PE), polyamide (PA), polybutylene terephthalate (PBT), polyethylene terephthalate (PET), polyester, polyphenylene oxide, polyacetal, polymethacrylate, polyoxymethylene, polyvinylacetal, polystyrene, acrylonitrile-butadiene-styrene (ABS), acrylonitrile-styrene-acrylic ester (ASA), polycarbonate, polyethersulphone, polyetherketone, polyvinylchloride, thermoplastic polyurethane and/or their copolymers and/or mixtures thereof.

The material according to the invention can be produced in any form according to the respective use involved. As however germs accumulate predominantly on the surface of materials, the advantages of the antimicrobial properties are particularly significant in relation to materials of large surface area. In a preferred embodiment of the invention the material of the invention is therefore in the form of a film, coating or thin layer of a thickness in the range of 1 μm to 20 mm or in the range of 50 μm to 10 mm or in the range of 100 μm to 5 mm or in the range of 200 μm to 1 mm. Such film materials are suitable for example as packaging materials, films for the storage of foodstuffs, linings of containers and rooms in which an antimicrobial action is desired, such as for example a swimming pool film and so forth.

The invention also involves the use of inorganic phosphate salts of at least two different metal cations, wherein at least one of the metal cations is selected from copper (Cu) and zinc (Zn), for the antimicrobial treatment of a matrix material, wherein the inorganic phosphate salts are contained in the matrix material in finely distributed, dispersed or dissolved form.

The invention further involves the use of the above-described material for the production of packaging materials for commercial products, preferably packaging materials for foodstuffs, cosmetic agents, medicines or medical products or for the production of medical products or plastic tubes.

A further advantage of the use according to the invention of a combination of metal phosphates is that, in contrast to pure metals or metal oxides, they can be incorporated into almost any matrix. As described hereinbefore in that respect thermoplastic materials, elastomers and thermosetting materials but also ceramics, silicones, cellulose derivatives, pastes and ointments, lacquers and paints and further matrices can be used as the matrix material.

Suitable matrix materials according to the invention are additionally listed hereinafter:

polyolefins such as polyethylene, polypropylene, polybutylene, polymethylpentene as well as block, graft and copolymers thereof;

styrene polymers such as standard polystyrene, impact-resistant polystyrene, styrene acrylonitrile, acrylonitrile-butadiene-styrene, acrylonitrile-styrene, acrylic rubber;

halogen-bearing vinylpolymers such as polyvinyl chloride, polyvinylidene chloride, polyvinyl fluoride, tetrafluoromethylene-hexafluoromethylene copolymer, ethylene-tetrafluoroethylene copolymer, polychlorotrifluoroethylene, ethylene-chlorotrifluoroethylene copolymer;

acrylic polymers such as polyacrylate and polymethacrylate;

polyacetals such as polyoxymethylene;

linear polycondensates such as polyamides (PA-6, PA-66, PA-610, PA-612, PA-11, PA-12 etc.), polycarbonates, polyesters (for example polyethylene terephthalate, polybutylene terephthalate etc.), polyimides, polyarylketones, polysulfones, polyurethanes and polyphenylenes;

polymers of unsaturated alcohols and amines or acyl derivatives or acetals thereof such as polyvinyl alcohol, polyvinyl acetates, polyvinyl butyral and polyvinyl benzoate;

crosslinked polycondensates, polyadducts such as phenoplasts, aminoplasts, epoxy resins, unsaturated polyesters and polyurethane;

modified natural substances such as cellulose ester;

copolymers or mixtures of the aforementioned polymers, optionally in the presence of additives such as processing aids, stabilisers, anti-oxidants, dyestuffs, dispersing aids, fillers etc.;

cellulose;

ceramic materials: clay and porcelain;

ceramic coatings: engobes and glaze;

thermosetting materials;

silicones.

### EXAMPLES

### QualiScreen Test on Antimicrobial Properties of Materials or Material Surfaces

The test available under the name QualiScreen from QualityLabs BT GmbH,

Nuremberg, Germany (www.qualitylabs-bt.de) was used to investigate and quantitatively classify the antimicrobial properties of materials or material surfaces.

The QualiScreen test is a standardised, validated and certified test process which is suitable for different materials such as polymers, fibres, ceramic, metal, paints, coatings and so forth and for different forms of material such as flat, cylindrical and spherical surfaces and different surfaces such as rough, smooth, hydrophilic, hydrophobic and so forth. Usually up to 20 samples are investigated simultaneously in the test in a quadruple determination in respect of their antimicrobial properties.

The results are given in log stages in respect of the reduction in germ growth prevention. 3 log stages denote a germ growth prevention of at least 99.9% of the daughter cells during the observation period in comparison with a comparison sample without germ growth prevention. (2 log stages=99%, 3 log stages=99.9%, 4 log stages=99.99%, 5 log stages=99.999% and so forth). 3 log stages and more are classified as “antimicrobial”. The log stages can also be associated with nett time durations in respect of germ growth prevention in relation to a comparative sample without germ growth prevention. The period of time until a threshold value in respect of bacterial growth density was reached in the sample is measured, being measured as OD (optical density) at a predetermined absorption wavelength. The nett period of time of a sample is the difference between the actual period of time until the attainment of the threshold value of the bacterial growth density at the measurement sample (gross period of time of the measurement sample) and the gross period of time of the comparative sample without germ growth prevention.

A nett period of 2 hours corresponds to 2 log stages, a nett period of 5 hours corresponds to 3 log stages, a nett period of 8 hours corresponds to 4 log stages and so forth. The distance between two log stages thus corresponds to 3 hours, as it is assumed that a bacteria population multiplies approximately by ten times under test conditions within 3 hours.

In the present examples Staphylococcus epidermidis (DSM 18857) was used as the test germ in the QualiScreen test.

### Investigation of the Antimicrobial Action of Various Metal Phosphate Additives

Various metal phosphates were incorporated into a PE matrix and the antimicrobial properties of the products were investigated and compared in the QualiScreen test. For the production process the molten PE matrix was mixed in the extruder with the phosphate or phosphates.

The compositions and the results are reproduced in Table 1 below. Quadruple determination processes were performed in each case.

TABLE 1
Samples and germ growth results from Example 1

| Sample | | Concentration | Log stages |
|---|---|---|---|
| # | Metal phosphate additive | [% by weight] | (nett hours) |
| 1 | Ag₃PO₄ | 1.0% | 4 (10.0) |
| 2 | Cu₂(OH)PO₄ | 5.0% | 3 (5.4) |
| | (copper hydroxide | | |
| | phosphate) | | |
| 3 | Zn(H₂PO₄)₂ | 5.0% | 3 (5.5) |
| | (monozinc phosphate) | | |
| 4 | Cu₂(OH)PO₄ + Zn(H₂PO₄) | 3.0% + 2.0% | 7 (18.7) |

The test results show the effect of copper and/or zinc phosphates on the antimicrobial properties of a polymer material. The antimicrobial action of the copper and zinc phosphates alone is already outdone at a much lower concentration of the silver phosphate, by the action of the silver phosphate used for the comparison. It will be noted however that there is an endeavour to eliminate silver salts by virtue of the above-mentioned properties of silver, being harmful to health. The results further demonstrate a synergistic effect of the combination of the copper and zinc phosphates in relation to the respective actions of the individual phosphates at the same overall concentration (5% by weight).

1-11. (canceled)

12. An antimicrobially treated material comprising a matrix material in which inorganic phosphate salts of the at least two different metal cations copper (Cu) and zinc (Zn) are contained in finely distributed, dispersed or dissolved form, wherein the inorganic phosphate salts are selected from copper hydroxide phosphate Cu₂(OH)PO₄, tricopper phosphate Cu₃(PO₄)₂, copper-II-pyrophosphate Cu₂P₂O₇, monozinc phosphate Zn(H₂PO₄)₂, trizinc phosphate Zn₃(PO₄)₂ and zinc pyrophosphate Zn₂P₂O₇, and wherein the matrix material is selected from the organic polymer materials polyvinylbutyral (PVB), polypropylene (PP), polyethylene (PE), polyamide (PA), polybutylene terephthalate (PBT), polyethylene terephthalate (PET), polyester, polyphenylene oxide, polyacetal, polymethacrylate, polyoxymethylene, polyvinylacetal, polystyrene, acrylonitrile-butadiene-styrene (ABS), acrylonitrile-styrene-acrylic ester (ASA), polycarbonate, polyethersulphone, polyetherketone, polyvinylchloride, thermoplastic polyurethane and/or their copolymers and/or mixtures thereof.

13. A material according to claim 12, wherein at least one of the metal phosphate salts is acid phosphate.

14. A material according to claim 12, wherein at least two inorganic metal phosphate salts in the matrix material are contained in an amount respectively of 0.001 to 40% by weight or 0.05 to 10% by weight or 0.5 to 5% by weight or 1 to 3% by weight.

15. A material according to claim 12, wherein at least two inorganic metal phosphate salts are respectively of a mean particle size (d50) in the range of 1 nm to 20 μm, preferably 10 nm to 10 μm, particularly preferably 20 nm to 1 μm, quite particularly preferably 40 nm to 200 nm.

16. A material according to claim 12, wherein it is in the form of a film, coating or thin layer of a thickness in the range of 1 μm to 20 mm or in the range of 50 μm to 10 mm or in the range of 100 μm to 5 mm or in the range of 200 μm to 1 mm.

17. Use of inorganic phosphate salts of the at least two different metal cations copper (Cu) and zinc (Zn), wherein the inorganic phosphate salts are selected from copper hydroxide phosphate Cu₂(OH)PO₄, tricopper phosphate Cu₃(PO₄)₂, copper-II-pyrophosphate Cu₂P₂O₇, monozinc phosphate Zn(H₂PO₄)₂, trizinc phosphate Zn₃(PO₄)₂ and zinc pyrophosphate Zn₂P₂O₇ for the antimicrobial treatment of a matrix material selected from the organic polymer materials polyvinylbutyral (PVB), polypropylene (PP), polyethylene (PE), polyamide (PA), polybutylene terephthalate (PBT), polyethylene terephthalate (PET), polyester, polyphenylene oxide, polyacetal, polymethacrylate, polyoxymethylene, polyvinylacetal, polystyrene, acrylonitrile-butadiene-styrene (ABS), acrylonitrile-styrene-acrylic ester (ASA), polycarbonate, polyethersulphone, polyetherketone, polyvinylchloride, thermoplastic polyurethane and/or their copolymers and/or mixtures of selected matrix materials, wherein the inorganic phosphate salts in the matrix material are contained in finely distributed, dispersed or dissolved form.

18. Use of the material according to claim 12 for the production of packaging materials for commercial products, preferably packaging materials for foodstuffs, cosmetic agents, medicines or medical products, or for the production of medical products or plastic tubes.
